(19) United States
(12) Patent Application Publication
(10) Pub. No.: US 2007/0281191 A1
(43) Pub. Date: Dec. 6, 2007

(54) Fuel cell apparatus

(76) Inventor: Motoi Goto, Tachikawa-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/805,358

(22) Filed: May 22, 2007

(30) Foreign Application Priority Data
May 31, 2006 (JP) 2006-152168

(51) Int. Cl. H01M 8/24; H01M 8/04

(52) U.S. Cl. 429/18; 429/14

(57) ABSTRACT

According to one embodiment, a fuel cell apparatus includes a power generator portion which has an anode and a cathode and generates electricity, a fuel tank containing fuel, and a circulating system which supplies fuel and air to the power generator portion. The circulating system includes a fuel passage which allows fuel to circulate through the anode, a gas passage which allows air to circulate through the cathode, and a gas-liquid separator which is provided in the fuel passage between an outflow end of the power generator portion and the fuel tank and separates the fluid into liquid and gas. The gas-liquid separator is connected to the power generator portion so that a flow rate of the fluid that flows from the outflow end of the power generator portion to an inflow end of the gas-liquid separator is 40% or less of a tank capacity of the fuel tank.

### CROSS-REFERENCE TO RELATED APPLICATIONS

This application is based upon and claims the benefit of priority from Japanese Patent Application No. 2006-152168, filed May 31, 2006, the entire contents of which are incorporated herein by reference.

### BACKGROUND

1. Field

One embodiment of the present invention relates to a fuel cell apparatus used as a power source for electronic devices and the like.

2. Description of the Related Art

A secondary battery such as a lithium ion battery is now mainly used as a power source in use for electronic devices such as a portable, notebook type personal computer (to be referred to as a notebook PC) and a mobile device. Recent high-performance electronic devices bring about increase of power consumption and elongation of the device use time. In this circumstance, a micro fuel cell is expected as a new type high-power source which does not need to be charged. There are many types of fuel cells. Of those fuel cells, particularly the direct methanol fuel cell (DMFC) using methanol solution as liquid fuel has attracted attention as a power source for electronic devices since the fuel handling is easier and the system construction is simpler than the fuel cells using hydrogen as fuel.

Normally, the DMFC includes a fuel tank containing methanol, a liquid feeding pump for press-feeding the methanol to a power generator portion, and an air feeding pump for feeding air to the power generator portion. The power generator portion includes a cell stack in which a plurality of unit cells each having an anode and a cathode are stacked. The power generator portion generates electricity through a chemical reaction when the diluted methanol is fed to the anode of the cell stack and air is fed to the cathode. The reaction by-products as the result of electricity generation are unreacted methanol and carbonic acid produced at the anode and water at the cathode. The water as the reaction by-product is exhausted in the form of steam.

A gas-liquid separator is provided in the passage extending between the exit of the anode in the power generator portion and the fuel tank, as disclosed in Jpn. Pat. Appln. KOKAI Publication No. 2005-108718, for example. The unreacted methanol and the carbonic acid gas, which are produced at the anode of the power generator portion, are sent to the gas-liquid separator where those are separated into methanol and carbonic acid gas. Following the separation, the methanol is sent to the fuel tank through a recovery passage, while the carbonic acid gas is sent to a cathode passage through an exhaust passage.

In the fuel cell apparatus constructed as mentioned above, the fluid exhausted from the anode exit of the power generator portion contains the unreacted methanol and the carbonic acid gas. In this case, a volume expansion of the gas occurs when the exhausted fluid flows from the power generator portion to the gas-liquid separator. As a result, the pressure in the pipe coupling the power generator portion and the gas-liquid separator rises, and the pressure rise acts on the fuel tank through the liquid passage to lift the liquid level of the fuel in the fuel tank. Usually, the fuel tank contains therein a water level sensor which detects a liquid surface height of the fuel contained to detect the quantity of residual fuel based on the detected water level. When the rise of the pressure in the fuel passage raises the liquid level as in the above case, it is difficult to accurately measure the quantity of residual fuel. In this case, excessive fuel or fuel shortage occurs, leading to lowering of the reliability of the fuel cell apparatus.

The fuel having undergone the gas-liquid separation process in the gas-liquid separator is returned to the fuel tank and used again for the power generation. Accordingly, to efficiently utilize the fuel, it is essential that the gas-liquid separator located between the power generator portion and the fuel tank is capable of reliably separating the incoming fluid into the fuel and the carbonic acid gas.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a circulation system in a fuel cell apparatus according to a first embodiment of the present invention;

FIG. 2 is an exemplary cross sectional view showing a Cell stack and a gas-liquid separator in the fuel cell apparatus;

FIG. 3 is a view schematically showing a unit cell of the Cell stack;

FIG. 4 is a view showing a relation between an air passage in the fuel cell apparatus and pressures at each point in the air passage; and

FIG. 5 is an exemplary block diagram showing a circulation system in a fuel cell apparatus according to a second embodiment of the present invention.

### DETAILED DESCRIPTION

Various embodiments according to the invention will be described hereinafter with reference to the accompanying drawings. In general, according to an embodiment of the invention, a fuel cell apparatus comprises: a power generator portion which includes cells each having an anode and a cathode and generates electricity through a chemical reaction; a fuel tank containing fuel; and a circulating system having: a fuel passage which allows fuel fed from the fuel tank to circulate through the anode of the power generator portion; a gas passage which allows air to circulate through the cathode of the power generator portion; and a gas-liquid separator which is provided in the fuel passage between an outflow end of the power generator portion and the fuel tank and separates the fluid into liquid and gas, the gas-liquid separator being connected to the power generator portion so that a flow rate of the fluid that flows from the outflow end of the power generator portion to an inflow end of the gas-liquid separator is 40% or less of a tank capacity of the fuel tank.

According to another aspect of the invention, a fuel cell apparatus comprises: a power generator portion which includes cells each having an anode and a cathode and generates electricity through a chemical reaction; a fuel tank containing fuel; and a circulating system having: a fuel passage which allows fuel fed from the fuel tank to circulate through the anode of the power generator portion; a gas passage which has an intake end and an exhaust end and supplies air through the cathode of the power generator portion; a air feeding pump which is provided in the gas passage at a position between an intake port of the gas passage and the power generator portion, sucks air from the intake end and supplies the air to the power generator portion; a gas-liquid separator which is provided between an outflow end of the power generator portion and the fuel tank in the fuel passage and separates the fluid into liquid and gas and; and an exhaust passage which extends from the gas-liquid separator to the gas passage and guides the gas separated by the gas-liquid separator to the gas passage, the gas-liquid separator including a separation pipe defining the liquid passage, a case covering the separation pipe and connected to the exhaust passage, and a separation film provided in the separation pipe and allowing gas to permeate therethrough, the gas-liquid separator being configured to separate gas from the fluid flowing through the separation pipe by a pressure difference between a first pressure in the separation pipe and a second pressure in the case and discharge the gas to the case through the separation film, and the exhaust passage being connected to the gas passage at a position where the second pressure is higher than the first pressure.

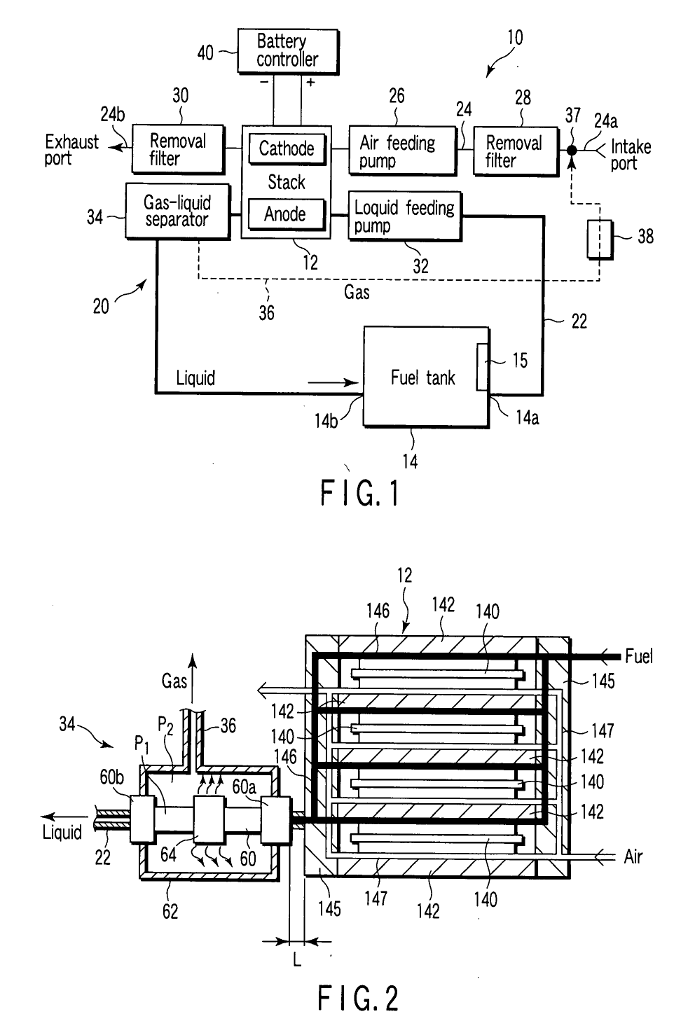

FIG. 1 shows an arrangement of a circulation system of a fuel cell apparatus according to a first embodiment of the invention. As shown in FIG. 1, the fuel cell apparatus 10 is constructed as a DMFC using methanol as liquid fuel. The fuel cell apparatus 10 comprises a cell stack 12 forming a power generator portion, a fuel tank 14, and a circulation system 20 for supplying fuel and air to the cell stack 12.

The fuel tank 14 has a hermetically closed structure and contains methanol as liquid fuel. The fuel tank 14 may take the form of a fuel cartridge, which is detachably attached to the fuel cell apparatus 10. The fuel tank 14 is provided with a water level sensor 15 which measures a height of a liquid surface (water level) of the methanol contained in the fuel tank and detects the quantity of the residual fuel.

The circulation system 20 includes a fuel passage (liquid passage) 22 for circulating fuel supplied from a fuel supply port 14a of the fuel tank 14 through the cell stack 12, an air passage (gas passage) 24 for circulating gas containing air through the cell stack 12, and a plurality of auxiliary devices provided in the fuel passage and the air passage. The fuel passage 22 and the air passage 24 are respectively formed with pipes, for example.

The air passage 24 includes an intake end 24a with an intake port and an exhaust end 24b with an exhaust port. An air feeding pump 26 is installed in the air passage 24 between the intake end 24a and the cell stack 12. The air feeding pump 26 sucks air into the air passage 24 through the intake end 24a and feeds the air to the cathode (air electrode) of the Cell stack 12 through the air passage.

An intake-side removal filter 28 is installed in the air passage 24 between the intake end 24a and the air feeding pump 26. The intake-side removal filter 28, which forms a removal part, filters out dust, impurities such as carbon dioxide, formic acid, fuel gas, and methyl formate, and harmful substances, which are contained in the air flowing through the air passage 24. An exhaust-side removal filter 30 is installed in the air passage 24 between the outflow terminal of the cell stack 12 and the exhaust end 24b. The exhaust-side removal filter 30, which forms the removal part, filters out impurities such as carbon dioxide, formic acid, fuel gas, and methyl formate, and harmful substances, which are contained in the air flowing through the air passage 24.

The fuel passage 22 extends from the fuel supply port 14a of the fuel tank 14 to the fuel recovery port 14b of the fuel tank 14 through the anode (fuel electrode) of the cell stack 12. The auxiliary devices provided in the fuel passage 22 are a liquid feeding pump 32, which is provided in the fuel passage 22 between the fuel supply port 14a of the fuel tank 14 and the cell stack 12, and a gas-liquid separator 34, which is provided in the fuel passage between the outflow terminal of the cell stack and the fuel recovery port 14b of the fuel tank 14. The liquid feeding pump 32 pressurizes the methanol fed from the fuel tank 14 and supplies the pressurized methanol to the anode of the cell stack 12.

The gas-liquid separator 34 separates the fluid flowing through the fuel passage 22 into liquid and gas, that is, as described later, the fluid into the unreacted methanol and carbon dioxide as the reaction by-product, which have been discharged from the cell stack 12. The separated liquid, methanol in this instance, is recovered into the fuel tank 14 through the fuel passage 22 and the fuel recovery port 14b.

The circulation system 20 includes an exhaust passage 36, defined by piping or the like and extending from the gas-liquid separator 34 to the air passage 24, and a heater 38 for heating the fluid flowing through the exhaust passage. The exhaust passage 36 is coupled to the air passage 24 at a position located upstream of the removal filters 28 and 30. For example, the exhaust passage 36 is coupled to the air passage 24 at a connection position 37 between the intake end 24a and the intake-side removal filter 28.

The gas containing the carbon dioxide separated by the gas-liquid separator 34 is fed to the air passage 24 through the exhaust passage 36. At this time, the fluid flowing through the exhaust passage 36 is heated by the heater 38, so that the water content in the fluid evaporates. The gas fed from the exhaust passage 36 to the air passage 24 passes through the removal filter 28 which in turn filters out impurities such as carbon dioxide, formic acid, fuel gas, and methyl formate, and harmful substances, and then the fluid passes through the air feeding pump 26, the Cell stack 12, and the removal filter 30, and is finally exhausted from the ventilation port.

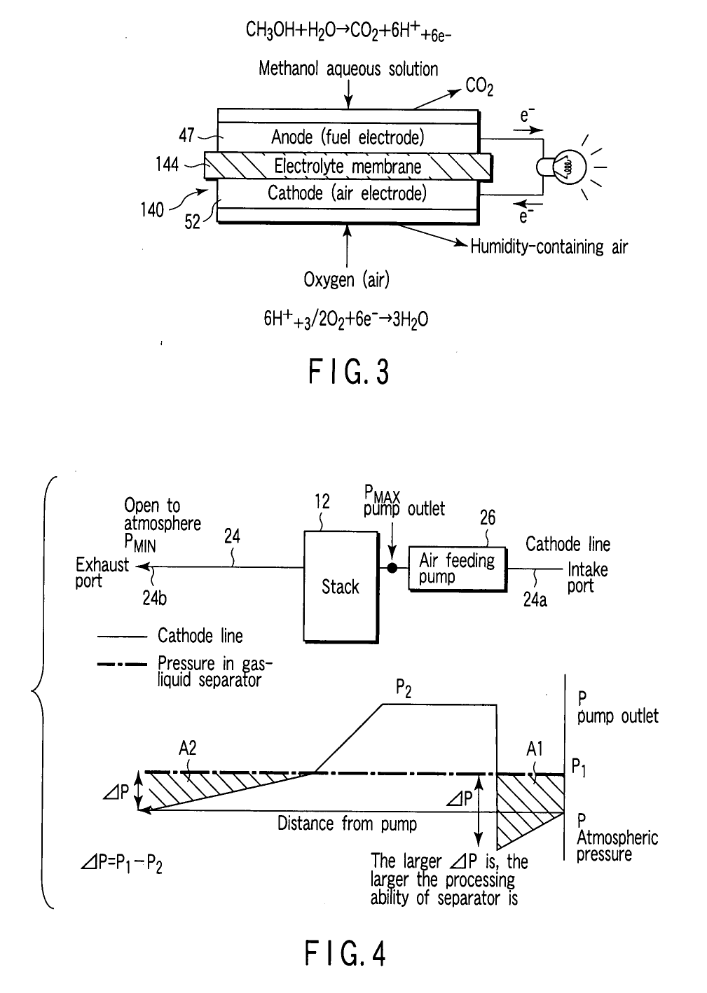

FIG. 2 shows a stack structure of the cell stack 12 and the gas-liquid separator 34, and FIG. 3 schematically shows a power generation reaction of each cell. As shown in FIGS. 2 and 3, the cell stack 12 includes a stack body in which a plurality (e.g., four) of unit cells 140, and five plate-shaped separators 142 are alternately stacked, and a frame 145 supporting the stack body. Each unit cell 140 contains a membrane electrode assembly (MEA) which is an assembly of a rectangular cathode 52 and an anode 47, each being formed with a catalyst layer and a carbon paper, and a rectangular polyelectrolyte film 144 sandwiched between the cathode and the anode. An area of the polyelectrolyte film 144 is larger than that of each of the anode 47 and the cathode 52.

The three separators 142 are stacked between the adjacent two unit cells 140, respectively, and the remaining two separators are placed on both ends of the stack as viewed in the stacking direction. A fuel passage 146 for supplying fuel to the anode 47 of each unit cell 140 and an air passage 147 for supplying air to the cathode 52 of each unit cell are formed in the separators 142 and the frame 145.

As shown in FIG. 3, the supplied fuel and air chemically react with each other in the polyelectrolyte film 144 provided between the anode 47 and the cathode 52 to generate electricity between the anode and the cathode. As shown in FIG. 1, the electric power generated in the cell stack 12 is supplied through a battery controller 40 to electronic devices and the like. The battery controller 40 controls the operations of the air feeding pump 26, the liquid feeding pump 32, and the heater 38, detects a quantity of residual fuel from a detection signal from the water level sensor 15, and controls the overall fuel cell apparatus.

As shown in FIG. 2, the gas-liquid separator 34 includes a separation pipe 60 which defines the fuel passage (liquid passage), a hollowed case 62 which covers the separation pipe 60, and a separation film 64 which is provided in the separation pipe and allows gas to permeate therethrough. The separation pipe 60 extends through the case 62, and the separation film 64 is located in the hollowed case 62. The inflow end 60a of the separation pipe 60 is coupled to the outflow end of the cell stack 12, which is closer to the anode. The outflow end 60b of the separation pipe 60 is connected to the fuel passage 22. The inside of the case 62 communicates with the exhaust passage 36.

The fuel supplied from the fuel passage 22 to the cell stack 12 flows to the anode 47, flows from the outflow end of the cell stack 12, which is closer to the anode, to the separation pipe 60, and flows from the outflow end 60b into the fuel passage 22. Assuming that an inner pressure (first pressure) in the separation pipe 60 is P1 and an inner pressure (second pressure) in the case 62 is P2 (<P1), the fluid flowing in the separation pipe 60 is separated into gas and liquid under a pressure difference ΔP between the pressures P1 and P2 (ΔP=P1−P2). The liquid separated is fed to the fuel passage 22. The gas separated permeates through the separation film 64 and enters the case 62, and passes through the exhaust passage 36 and reaches the air passage 24.

The larger the pressure difference ΔP is, i.e., the lower the pressure P2 in the case 62 is, the higher the gas-liquid separation ability of the gas-liquid separator 34 is. The pressure P2 in the case 62 is proportional to the pressure in the air passage 24 to which the exhaust passage 36 is connected. For this reason, the air passage 24 is connected to a position where the pressure is low in the air passage 24.

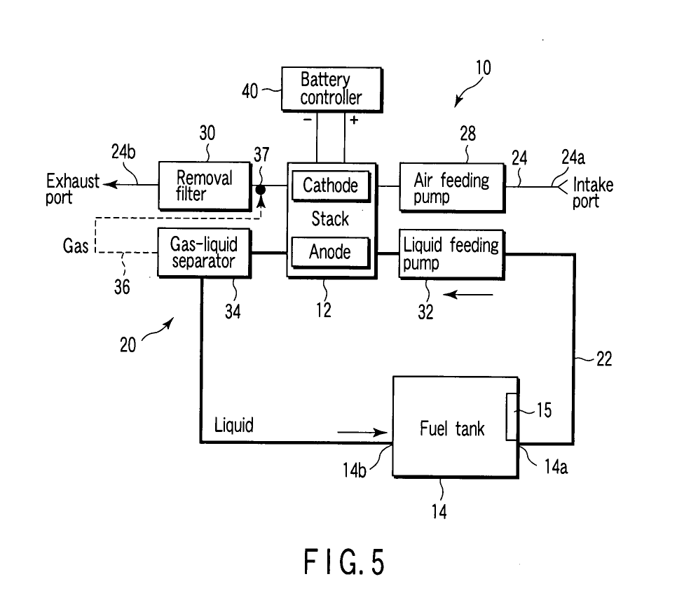

FIG. 4 shows a relationship between position in the air passage 24 and pressure. As shown in FIG. 4, a section of the air passage between the intake port and the intake side of the air feeding pump 26 is at a negative pressure, and the pressure in the section is sufficiently lower than the pressure P1 in the separation pipe 60. The gas in the air passage 24 is pressurized by the air feeding pump 26. Then, the gas passes through the cell stack 12, and its pressure gradually decreases when it flows through the stack. The gas leaves the cell stack and its pressure gradually decreases up to the atmospheric pressure. Thus, the pressure in the air passage 24 is lower than the pressure P1 in the separation pipe 60 in the section (A1 in FIG. 4) between the intake port and the air feeding pump 26 and in the section (A2) between the outflow end of the cell stack 12 and the exhaust port. The connection position 37 between the exhaust passage 36 and the air passage 24 is selected to be a position where the pressure P2 is lower than the pressure P1, i.e., a position within the section (A1) between the intake port and the air feeding pump 26 or a position within the section (A2) between the outflow end of the cell stack 12 and the exhaust port. In the instant embodiment, as shown in FIG. 1, the exhaust passage 36 is connected to the air passage 24 between the intake end 24a and the air feeding pump 26. With such an arrangement, the pressure difference ΔP in the gas-liquid separator 34 is large and hence, the gas-liquid separation ability of the gas-liquid separator is enhanced.

As shown in FIGS. 1 and 2, the gas-liquid separator 34 is coupled to the cell stack 12 between the cell stack 12 and the fuel tank 14 so that a flow rate of fluid which flows from the fuel outflow end of the cell stack 12 to the inflow end 60a of the gas-liquid separator is 40% or smaller of the tank capacity of the fuel tank 14.

In the case where the fuel outflow end of the cell stack 12 and the inflow end 60a of the gas-liquid separator are interconnected by a pipe L as shown in FIG. 2, the level of the liquid contained in the fuel tank 14 varies depending on the volume of the inside of the pipe L, i.e., a flow rate of the fluid flowing from the fuel outflow end of the cell stack 12 to the inflow end 60a of the gas-liquid separator. Thus, the volume of the inside of the pipe L is defined as follows:

Assuming that the inside dimension of the fuel tank 14 is 45 mm×45 mm with a height of 10 mm, and a capacity of the tank is about 20 cc, a tank capacity that can be assigned to an increase of the volume of the pipe L was calculated using the following fuel cell characteristics as reference.

Fuel Cell Characteristics:

Liquid level variation to volume variation=0.5 mm/cc

Liquid level in normal operation=5 mm (CO₂ increase+initial liquid level)

Liquid quantity variation=about 0.2 cc/min

CO₂ quantity generated by power generation=about 6 cc (liquid level lift: 3 mm)

In the case of the fuel tank 14, the liquid level of the contained liquid is about 0.5 mm with respect to the volume increase of 1 cc liquid quantity variation. Assuming that the reference liquid level used in the normal operation of the fuel cell apparatus is 5 mm, a volume increase of the pipe L is converted into a liquid level, and to a liquid level used in the normal operation, the total of the liquid levels is subtracted from the capacity of the fuel tank, and the resultant difference is a capacity that can be used for the liquid level control. Accordingly, the tank capacity that may be used for the water level control is gained by decreasing the volume increase of the pipe L.

When considering the liquid quantity increase based on the fuel cell characteristics, which are presented by way of example, it is found that about 10 minutes are enough for the tank to be filled with the fluid. It is desirable that a tolerance of the water level variation is at least ±1 mm when considering a variation of an inclination of the fuel tank and an abrupt change of the liquid quantity. When calculating a range of the water-level variation tolerance, a capacity of the tank that can be secured in the fuel tank as a capacity that increases in connection with the volume of the pipe L is 8 cc or less (40% of the tank capacity of 20 cc).

The volume of the pipe L is selected such that a flow rate of the fluid flowing from the fuel outflow end of the cell stack 12 to the inflow end 60a of the gas-liquid separator is 40% or less of the tank capacity of the fuel tank 14. The wording “40% or less” contains zero (0)%, and the inflow end 60a of the gas-liquid separator may be directly coupled to the fuel outflow end of the cell stack 12, not through the pipe L.

The maximum capacity is calculated allowing for the restrictions on the height of the fuel tank and on the mounting space, which are imparted with intention of the apparatus thinning. Further, the fuel cell characteristics are proper to the fuel cell. Accordingly, the maximum capacity varies depending on the specifications and the development subjects of the fuel cell apparatus.

Where the fuel cell apparatus 10 thus constructed is used for the power source, the liquid feeding pump 32 and the air feeding pump 26 are operated under the control of the battery controller 40. By the liquid feeding pump 32, the methanol is fed from the fuel tank 14 to the anode 47 of the cell stack 12, through the fuel passage 22.

By the air feeding pump 26, the atmosphere, or air, is sucked into the air passage, from the intake end 24a of the air passage 24. The air flows through the removal filter 28 which filters out dust and impurities, which are contained in the air. After passing through the removal filter 28, the air flows through the air passage 24 and reaches the cathode 52 of the cell stack 12.

The methanol and air fed to the cell stack 12 chemically react with each other in the polyelectrolyte film 144 located between the anode 47 and the cathode 52, whereby electricity is generated between the anode 47 and the cathode 52. The electric power generated in the cell stack 12 is supplied to electronic devices or the like through the battery controller 40.

With progress of the electrochemical reaction, the reaction by-products are generated in the cell stack 12, carbon dioxide is generated at the anode 47 and water at the cathode 52. The carbon dioxide generated at the anode 47 and unreacted methanol are sent to the gas-liquid separator 34 where those are separated from each other. The separated methanol is fed from the gas-liquid separator 34 to the fuel passage 22 and is recovered into the fuel tank 14 to be used again for power generation.

The separated carbon dioxide is sent through the exhaust passage 36 to the air passage 24, and is fed, together with the air, to the removal filter 28 where it is removed. The gas exhausted from the cell stack 12 contains impurities such as formic acid, methanol gas, and methyl formate and those impurities as well as the carbon dioxide are removed by the removal filter 28. As a result, it is possible to prevent the impurities from being fed to the air feeding pump 26 and the cell stack 12 and hence, to prevent damage of the air feeding pump and lowering of power generation efficiency caused by the impurities. The fluid flowing through the exhaust passage 36 is heated and dried by the heater 38 and the dried fluid is sent to the air passage 24. As a result, humidity is not fed to the air feeding pump 26 through the air passage 24 and the performance degradation of the air feeding pump caused by humidity is suppressed.

Most of the water generated at the cathode 52 of the cell stack 12 evaporates into steam, which in turn is exhausted into the air passage 24, together with the air. The water and steam that are exhausted are fed to the removal filter 30 which in turn filters off dust and impurities, and then are exhausted to outside from the exhaust end 24b of the air passage 24.

In the fuel cell apparatus 10 thus constructed, the gas-liquid separator located between the cell stack and the fuel tank is coupled to the cell stack so that a flow rate of the fluid that flows from the fuel outflow end of the cell stack to the inflow end of the gas-liquid separator is 40% or less of the tank capacity of the fuel tank. This feature reduces the water level lift in the fuel tank, which is caused by the volume expansion of the gas in the circulation system 20, and minimizes the adverse effect to the fluid control.

The gas that is separated by the gas-liquid separator and contains impurities is sent to the air passage and is filtered out, together with sucked air. The air from which the impurities have been removed is exhausted to outside. At this time, the gas exhausted from the gas-liquid separator is heated and dried, thereby suppressing the degradation of the performances of the air feeding pump. The exhaust side of the gas-liquid separator is connected to a low-pressure position in the air passage. This feature makes full use of the pressure difference to enhance the gas-liquid separation ability of the gas-liquid separator.

As seen from the foregoing description, it is possible to provide a fuel cell apparatus which is capable of accurately measuring the quantity of the fuel to prevent the fuel leakage, and highly reliably generating electricity. Moreover, there can be obtained a fuel cell apparatus which is capable of surely recovering the unreacted fuel and efficiently using the fuel.

A fuel cell apparatus according to a second embodiment of the present invention will now be described. As shown in FIG. 5, according to the second embodiment, an exhaust passage 36 extending from the case of the gas-liquid separator 34 is connected to a position between the outflow end of the cell stack 12 and an exhaust-side removal filter 30 in the air passage 24. The carbon dioxide separated by the gas-liquid separator 34 and other impurities are sent through the exhaust passage 36 to the air passage 24, and then to the removal filter 30. The carbon dioxide and the impurities are filtered out by the filter and exhausted to outside.

The second embodiment does not need the heater provided in the exhaust passage 36. Since the exhaust-side removal filter removes the impurities, the intake-side removal filter located upstream of the air feeding pump 28 may be omitted.

The remaining portion of the second embodiment is substantially the same as the corresponding portion of the first embodiment. Like or equivalent portions are designated by like reference numerals for simplicity. The second embodiment operates like the first embodiment, and produces useful effects comparable with those by the first embodiment.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In an alternative, a mixer for mixing fuel and water is provided, and the fuel and water generated at the power generator portion are mixed by the mixer, and the fuel diluted with the water is fed to the power generator portion. The fuel cell may be a polymer electrolyte fuel cell (PEFC) or any other type than a DMFC.

What is claimed is:

1. A fuel cell apparatus comprising:
a power generator portion which includes cells each having an anode and a cathode and generates electricity through a chemical reaction;
a fuel tank containing fuel; and
a circulating system having: a fuel passage which allows fuel fed from the fuel tank to circulate through the anode of the power generator portion; a gas passage which allows air to circulate through the cathode of the power generator portion; and a gas-liquid separator which is provided in the fuel passage between an outflow end of the power generator portion and the fuel tank and separates the fluid into liquid and gas,
the gas-liquid separator being connected to the power generator portion so that a flow rate of the fluid that flows from the outflow end of the power generator portion to an inflow end of the gas-liquid separator is 40% or less of a tank capacity of the fuel tank.

2. The fuel cell apparatus according to claim 1, wherein the inflow end of the gas-liquid separator is in contact with the outflow end of the power generator portion.

3. The fuel cell apparatus according to claim 1, wherein the circulating system includes an exhaust passage which extends from the gas-liquid separator to the gas passage and guides the separated gas from the gas-liquid separator to the gas passage.

4. The fuel cell apparatus according to claim 3, wherein the circulating system includes a removal member which is provided in the gas passage at a position downstream of a connection part between the gas passage and the exhaust passage, and which removes harmful substances from the gas flowing through the gas passage.

5. The fuel cell apparatus according to claim 4, wherein the air passage includes an intake end with an intake port and an exhaust end with an exhaust port, and the removal member includes a removal filter provided in the gas passage between the exhaust end and the power generator portion.

6. The fuel cell apparatus according to claim 5, wherein the exhaust passage is connected to the gas passage between the power generator portion and the removal filter.

7. The fuel cell apparatus according to claim 5, wherein the circulating system includes an air feeding pump which is provided in the gas passage between the intake port and the power generator portion and which sucks air through the intake portion and feeds the air to the power generator portion, and the exhaust passage is connected to the gas passage at a position between the intake port and the air feeding pump.

8. The fuel cell apparatus according to claim 7, wherein the removal member includes another removal filter provided in the gas passage at a position between the air feeding pump and a connection part between the exhaust passage and the gas passage.

9. The fuel cell apparatus according to claim 7, wherein the circulating system includes a heater which heats fluid flowing through the exhaust passage.

10. A fuel cell apparatus comprising:
a power generator portion which includes cells each having an anode and a cathode and generates electricity through a chemical reaction;
a fuel tank containing fuel; and
a circulating system having: a fuel passage which allows fuel fed from the fuel tank to circulate through the anode of the power generator portion; a gas passage which has an intake end and an exhaust end and supplies air through the cathode of the power generator portion; a air feeding pump which is provided in the gas passage at a position between an intake port of the gas passage and the power generator portion, sucks air from the intake end and supplies the air to the power generator portion; a gas-liquid separator which is provided between an outflow end of the power generator portion and the fuel tank in the fuel passage and separates the fluid into liquid and gas and; and an exhaust passage which extends from the gas-liquid separator to the gas passage and guides the gas separated by the gas-liquid separator to the gas passage,
the gas-liquid separator including a separation pipe defining the liquid passage, a case covering the separation pipe and connected to the exhaust passage, and a separation film provided in the separation pipe and allowing gas to permeate therethrough, the gas-liquid separator being configured to separate gas from the fluid flowing through the separation pipe by a pressure difference between a first pressure in the separation pipe and a second pressure in the case and discharge the gas to the case through the separation film, and
the exhaust passage being connected to the gas passage at a position where the second pressure is higher than the first pressure.

11. The fuel cell apparatus according to claim 10, wherein the exhaust passage is connected to the gas passage between the intake end and the air feeding pump.

12. The fuel cell apparatus according to claim 10, wherein the exhaust passage is connected to the gas passage between the exhaust end and the outflow end of the power generator portion.

13. The fuel cell apparatus according to claim 11, wherein the circulating system includes a removal member which is provided in the gas passage at a position downstream of a connection part between the gas passage and the exhaust passage and removes harmful substances from the gas flowing through the gas passage.

14. The fuel cell apparatus according to claim 12, wherein the circulating system includes a removal filter which is provided in the gas passage at a position between the air feeding pump and the connection part between the gas passage and the exhaust passage and which removes harmful substances from the gas flowing through the gas passage.

15. The fuel cell apparatus according to claim 14, wherein the circulating system includes a heater which heats fluid flowing through the exhaust passage.
